(19) United States
(12) Patent Application Publication
(10) Pub. No.: US 2026/0257286 A1
(43) Pub. Date: Sep. 3, 2026

(54) ROTARY TOOL AND METHOD FOR MANUFACTURING MACHINED PRODUCT

(71) Applicant: KYOCERA CORPORATION, Kyoto-shi, Kyoto (JP)

(72) Inventor: Yuki YOSHIKI, Omihachiman-shi, Shiga (JP)

(21) Appl. No.: 18/846,657

(22) PCT Filed: Mar. 6, 2023
(86) PCT No.: PCT/JP2023/008213

§ 371 Date: Sep. 13, 2024

(30) Foreign Application Priority Data
Mar. 14, 2022 (JP) 2022-039024

(51) Int. Cl. B23C 5/24; B23C 5/06

(52) U.S. Cl. CPC B23C 5/2472; B23C 5/06

(57) ABSTRACT

A rotary tool includes a holder, a cutting insert, and a screw. The holder extends from a front end toward a rear end along a rotation axis, and includes a pocket. The cutting insert is located in the pocket. The pocket includes a seating surface and a screw hole. The seating surface faces toward a front side in a rotation direction of the rotation axis. The screw hole extends from the seating surface toward a rear side in the rotation direction, and is configured to fix the screw. The holder further includes a connecting hole connecting to the screw hole. The connecting hole includes an opening that opens into an outer surface of the holder, and a connecting part connecting to the screw hole. The opening is located on a more rear side in the rotation direction than the connecting part.

### CROSS-REFERENCE TO RELATED APPLICATION

The present application claims priority to Japanese Patent Application No. 2022-039024, filed Mar. 14, 2022. The contents of this application are incorporated herein by reference in their entirety.

### TECHNICAL FIELD

The present disclosure relates to a rotary tool and a method for manufacturing a machined product. Examples of the rotary tool may include a so-called milling tool (milling cutter). The milling tool is usable for milling processes, such as face milling and end milling.

### BACKGROUND

For example, a rotary tool (milling tool) discussed in Japanese Unexamined Utility Model Registration Application Publication No. 7 -033517 (Patent Document 1) is known as a rotary tool. The rotary tool discussed in Patent Document 1 includes a holder (tool body), a cutting insert (indexable insert), and a screw. The holder includes a screw hole for engagement with the screw, and an escape hole communicating with the screw hole. The escape hole is a part for facilitating discharge of dust that tends to accumulate on a bottom of the screw hole to the outside.

However, the dust accumulated on the bottom of the screw hole might be poorly discharged in the rotary tool discussed in Patent Document 1. This is because dust tends to enter from an opening of the escape hole toward the bottom of the screw hole in the rotary tool discussed in Patent Document 1.

### SUMMARY

A rotary tool in a non-limiting embodiment of the present disclosure includes a holder, a cutting insert, and a screw. The holder extends from a front end toward a rear end along a rotation axis, and includes a pocket located on a side of the front end. The cutting insert is located in the pocket. The screw fixes the cutting insert to the holder. The pocket includes a seating surface and a screw hole. The seating surface faces toward a front side in a rotation direction of the rotation axis. The screw hole extends from the seating surface toward a rear side in the rotation direction, and is configured to fix the screw. The holder further includes a connecting hole connecting to the screw hole. The connecting hole includes an opening that opens into an outer surface of the holder, and a connecting part connecting to the screw hole. The opening is located on a more rear side in the rotation direction than the connecting part.

### BRIEF DESCRIPTION OF THE DRAWINGS

FIG. 1 is a perspective view illustrating a rotary tool in a non-limiting embodiment of the present disclosure;

FIG. 2 is a perspective view identical to FIG. 1, while seeing through a screw hole and a connecting hole;

FIG. 3 is a perspective view of the rotary tool illustrated in FIG. 1 as viewed from another direction;

FIG. 4 is a perspective view identical to FIG. 3, while seeing through the screw hole and the connecting hole;

FIG. 5 is a plan view of the rotary tool illustrated in FIG. 1 as viewed from a side of a front end;

FIG. 6 is a plan view identical to FIG. 5, while seeing through the screw hole and the connecting hole;

FIG. 7 is a side view of the rotary tool illustrated in FIG. 6 as viewed from VII direction;

FIG. 8 is a perspective of a holder in the rotary tool illustrated in FIG. 2;

FIG. 9 is a perspective view of the holder illustrated in FIG. 8 as viewed from another direction;

FIG. 10 is a plan view of the holder illustrated in FIG. 8 as viewed from a side of the front end;

FIG. 11 is a side view of the holder illustrated in FIG. 10 as viewed from XI direction;

FIG. 12 is a perspective view illustrating a rotary tool in a non-limiting embodiment of the present disclosure, while seeing through a screw hole and a connecting hole;

FIG. 13 is a perspective view of the rotary tool illustrated in FIG. 12 as viewed from another direction, while not seeing through the screw hole and the connecting hole;

FIG. 14 is a plan view of the rotary tool illustrated in FIG. 12 as viewed from a side of a front end;

FIG. 15 is a perspective view illustrating a rotary tool in a non-limiting embodiment of the present disclosure, while seeing through a screw hole and a connecting hole;

FIG. 16 is a side view of the rotary tool illustrated in FIG. 15, and corresponds to FIG. 7;

FIG. 17 is a perspective view of the rotary tool illustrated in FIG. 15 as viewed from another direction, while not seeing through the screw hole and the connecting hole;

FIG. 18 is a schematic diagram illustrating one of steps in a method for manufacturing a machined product in a non-limiting embodiment of the present disclosure;

FIG. 19 is a schematic diagram illustrating one of the steps in the method for manufacturing a machined product in the non-limiting embodiment of the present disclosure; and

FIG. 20 is a schematic diagram illustrating one of the steps in the method for manufacturing a machined product in the non-limiting embodiment of the present disclosure.

### EMBODIMENTS

### Rotary Tools

A rotary tool 1 in a non-limiting embodiment of the present disclosure is described in detail below with reference to the drawings. For convenience of description, the drawings referred to in the following illustrate, in simplified form, only main members necessary for describing embodiments. The rotary tool 1 may therefore include any arbitrary structural member not illustrated in the drawings referred to. Dimensions of the members in each of the drawings faithfully represent neither dimensions of actual structural members nor dimensional ratios of these members.

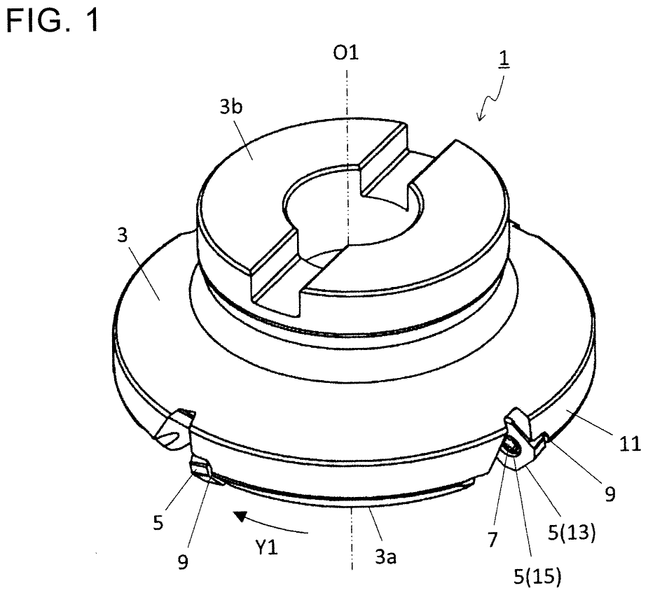

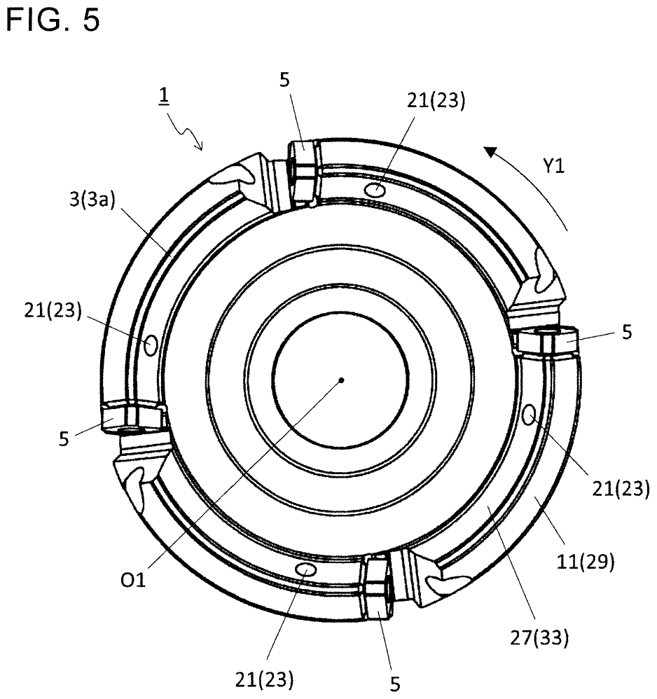

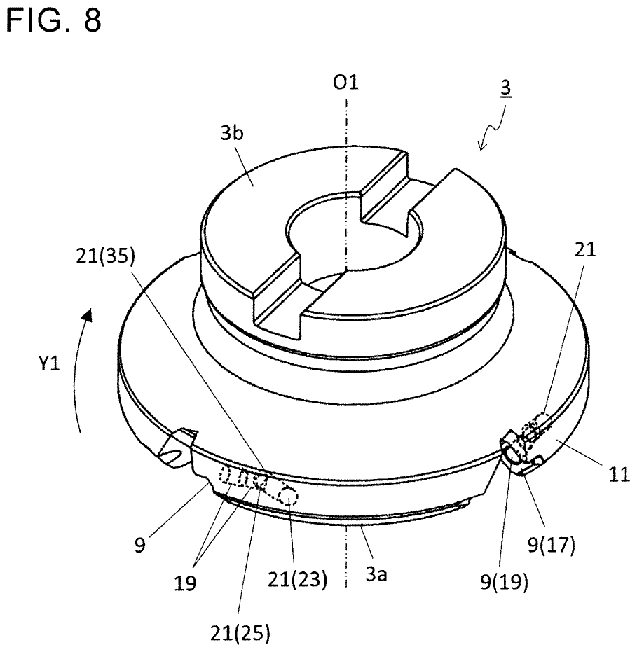

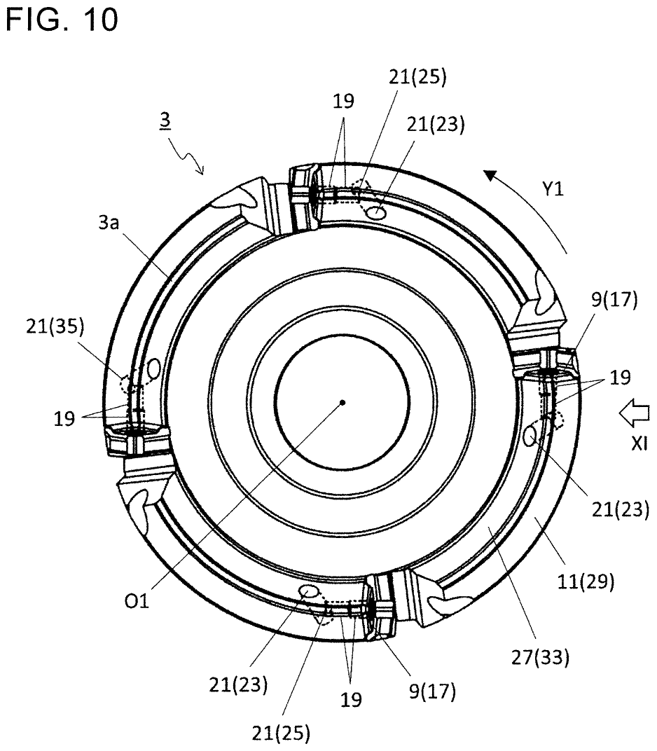

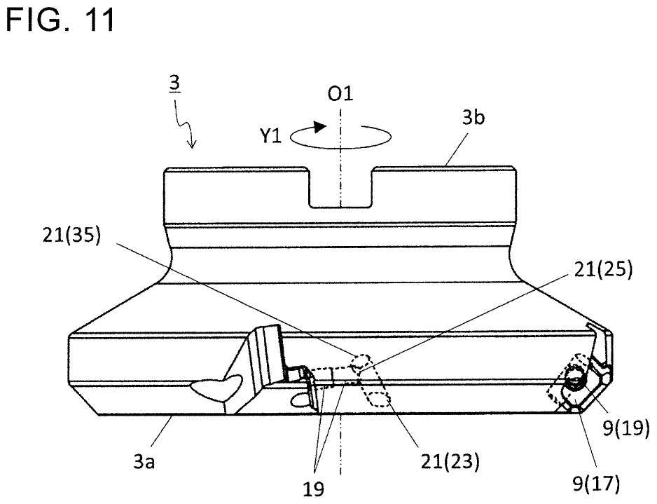

The rotary tool 1 may include a holder 3, a cutting insert 5, and a screw 7 as in a non-limiting embodiment illustrated in FIGS. 1 to 11.

The holder 3 may extend from a front end 3a toward a rear end 3b along a rotation axis O1, and may include a pocket 9 located on a side of the front end 3a. The holder 3 is rotatable around the rotation axis O1. An arrow Y1 in FIG. 1, etc. may indicate a rotation direction of the rotation axis O1, and may also indicate a rotation direction of the holder 3 around the rotation axis O1.

The pocket 9 permits attachment of the cutting insert 5. The pocket 9 may open into a side of the front end 3a in an outer surface 11 of the holder 3. There may be one or a plurality of pockets 9.

In cases where the holder 3 includes the plurality of pockets 9, these pockets 9 may be located at equal intervals or at unequal intervals around the rotation axis O1. In the case of including the plurality of pockets 9, the number of the pockets 9 may be approximately 2 to 20.

The holder 3 is not limited to having a specific size. For example, a length of the holder 3 in a direction along the rotation axis O1 may be set to approximately 40-100 mm. A width (diameter) of the holder 3 in a direction orthogonal to the rotation axis O1 may be set to approximately 40-350 mm.

The cutting insert 5 may be simply called the insert 5. The insert 5 is usable for machining a workpiece in a machining process. The insert 5 may be located in the pocket 9. If the holder 3 includes a plurality of pockets 9, the rotary tool 1 may include a plurality of inserts 5, and the inserts 5 may be located one by one in these pockets 9.

The insert 5 may include a cutting edge 13. The rotary tool 1 is capable of performing the machining process by bringing the cutting edge 13 of the insert 5 into contact with the workpiece. The insert 5 may be located in the pocket 9 so that at least a part of the cutting edge 13 can protrude from the holder 3.

The insert 5 may have a polygonal plate shape. The insert 5 may include a through hole 15. The through hole 15 may penetrate the insert 5 in a thickness direction. The through hole 15 may serve as a part for inserting the screw 7.

The screw 7 may be a member for fixing the insert 5 to the holder 3. The number of the screws 7 may be equal to the number of the inserts 5.

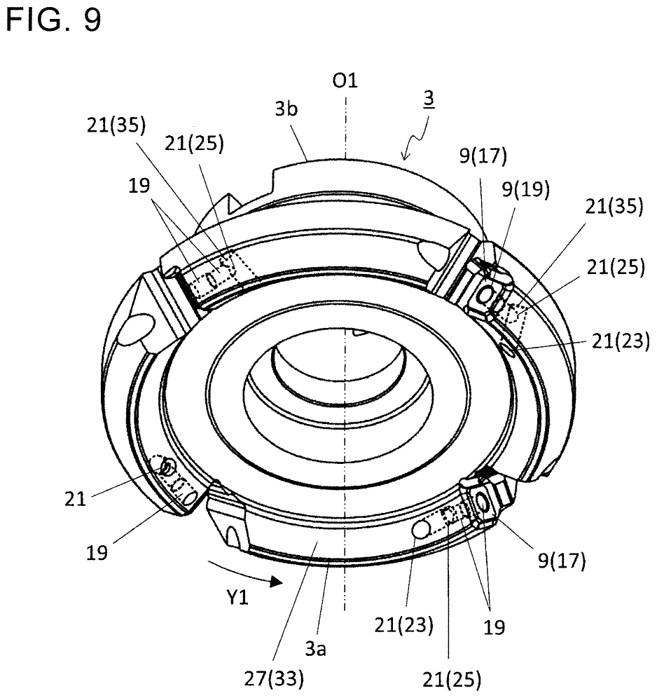

The pocket 9 may include a seating surface 17 and a screw hole 19 as in a non-limiting embodiment illustrated in FIG. 9.

The seating surface 17 may face toward a front side in the rotation direction Y1 of the rotation axis O1. The seating surface 17 is abuttable against (contactable with) the insert 5 when attaching the insert 5 to the holder 3.

The seating surface 17 may be flat. The term “flat” as used herein need not be a strict flat. In cases where the seating surface 17 is flat, the seating surface 17 may be approximately flat, and may be slightly curved or may have slight unevenness to such a degree that cannot be seen if the holder 3 is viewed as a whole. If the seating surface 17 is flat, the seating surface 17 may include slight unevenness of approximately several tens of μm.

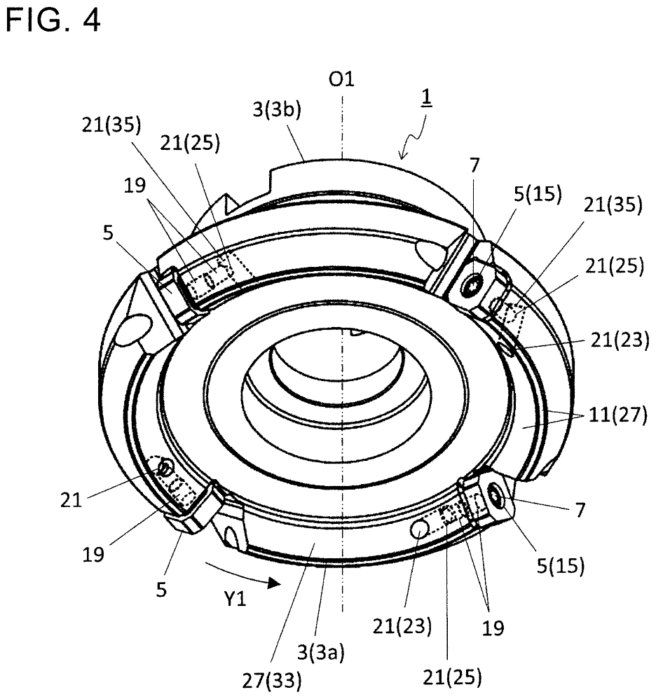

The screw hole 19 may extend from the seating surface 17 toward a rear side in the rotation direction Y1. The screw hole 19 permits fixing of the screw 7 (refer to FIG. 4). The screw hole 19 may open into the seating surface 17. The insert 5 can be fixed to the holder 3 by inserting the screw 7 into the through hole 15 of the insert 5, and by fixing the screw 7 to the screw hole 19.

The holder 3 may further include a connecting hole 21. The connecting hole 21 may connect to the screw hole 19. The connecting hole 21 may be also called an escape hole.

The connecting hole 21 may be inclined relative to the screw hole 19 as in a non-limiting embodiment illustrated in FIG. 10. With this configuration, it is easy to determine a boundary between the screw hole 19 and the connecting hole 21. The connecting hole 21 may not include a screw groove in an inner wall surface. Also, with this configuration, it is easy to determine the boundary between the screw hole 19 and the connecting hole 21. That is, if the connecting hole 21 does not include the screw groove in the inner wall surface, a part where the screw groove is located may be regarded as the screw hole 19, and a part where the screw groove is not located may be regarded as the connecting hole 21 in a cylindrical-shaped part extending from the seating surface 17 toward a rear side in the rotation direction Y1.

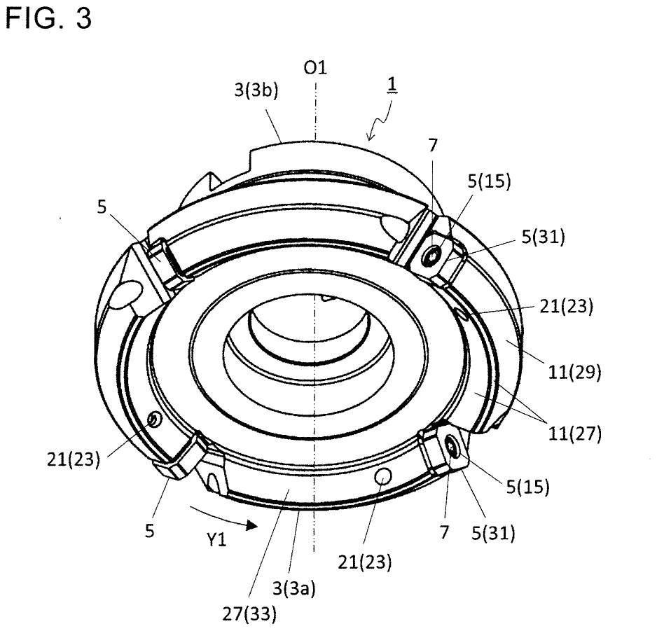

The connecting hole 21 may include an opening 23 and a connecting part 25 as in a non-limiting embodiment illustrated in FIGS. 3 and 4. The opening 23 may open into the outer surface 11 of the holder 3. The connecting part 25 may be the part connecting to the screw hole 19. The opening 23 may be located on a more rear side in the rotation direction Y1 than the connecting part 25. The phrase “the outer surface 11 of the holder 3 into which the opening 23 opens” as used herein may be the surface of the holder 3 exposed to the outside during the use of the rotary tool 1.

In the rotary tool disclosed in Patent Document 1, the escape hole (connecting hole) opens toward the front side in the rotation direction Y1. Therefore, dust (chips, etc.) is likely to enter the connecting hole when the rotary tool is rotated in use.

If the opening 23 is located on a more rear side in the rotation direction Y1 than the connecting part 25, the connecting hole 21 opens backward toward the rear side in the rotation direction Y1. Therefore, dust (chips, etc.) is less likely to enter the connecting hole 21 during the use of the rotary tool 1. Thus, with the rotary tool 1, the dust is less likely to accumulate on the bottom of the screw hole 19.

Additionally, if the opening 23 is located on the more rear side in the rotation direction Y1 than the connecting part 25, it is easy to maintain a thickness of the holder 3 between the pocket 9 and the opening 23. This leads to high durability of the holder 3. Moreover, if the opening 23 is located on the more rear side in the rotation direction Y1 than the connecting part 25, the screw hole 19 and the connecting hole 21 can easily intersect each other at an obtuse angle. Therefore, it is also easy to remove chips generated during formation of the screw hole 19.

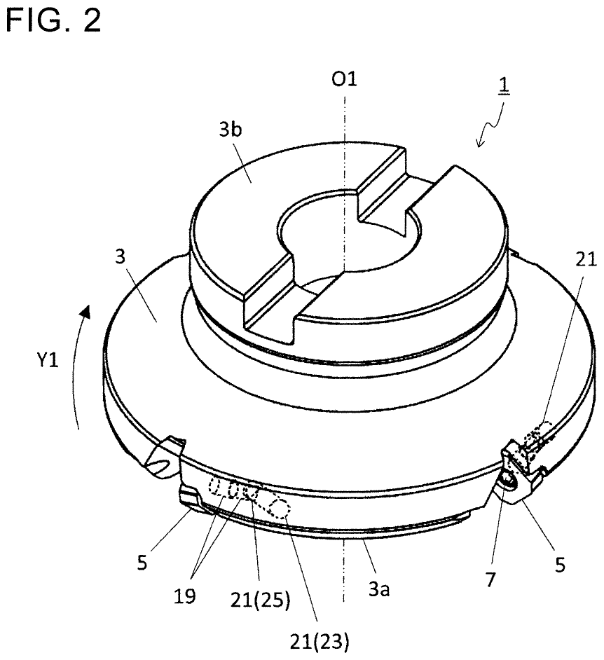

The connecting hole 21 may extend toward the rear side in the rotation direction Y1 as getting closer to the opening 23 from the connecting part 25 as in the non-limiting embodiment illustrated in FIG. 2. With this configuration, even if chips enter from the opening 23 into the connecting hole 21, it is easy to discharge the chips from the opening 23.

The connecting hole 21 may extend in a straight line shape toward the rear side in the rotation direction Y1 as getting closer to the opening 23 from the connecting part 25. This leads to high discharge performance against chips that have entered from the opening 23 into the connecting hole 21.

The outer surface 11 of the holder 3 may include a front end surface 27 and an outer peripheral surface 29 as in the non-limiting embodiment illustrated in FIG. 3. The front end surface 27 may be located on a side of the front end 3a. The outer peripheral surface 29 may extend from the front end surface 27 toward the rear end 3b. The outer peripheral surface 29 may be located on a more outer peripheral side than the front end surface 27.

The opening 23 may be located in the front end surface 27 as in the non-limiting embodiment illustrated in FIG. 3. With this configuration, chips are less likely to enter from the opening 23 into the connecting hole 21.

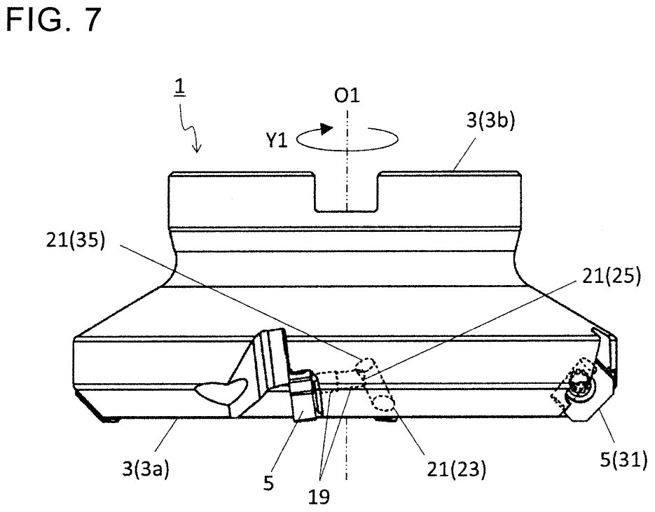

The connecting hole 21 may extend toward the front end 3a as getting closer to the opening 23 from the connecting part 25 as in a non-limiting embodiment illustrated in FIG. 7. With this configuration, even if chips enter from the opening 23 into the connecting hole 21, the chips can be easily discharged from the opening 23.

The connecting hole 21 may extend in a straight line shape toward the front end 3a as getting closer to the opening 23 from the connecting part 25. This leads to high discharge performance against chips that have entered from the opening 23 into the connecting hole 21.

The insert 5 may include an outer peripheral cutting edge 31 located on an outer peripheral side as in a non-limiting embodiment illustrated in FIG. 7. In other words, the cutting edge 13 may include the outer peripheral cutting edge 31 located on the outer peripheral side. The outer peripheral cutting edge 31 may fulfil a main role in a machining process of a workpiece. The outer peripheral cutting edge 31 may also be called a main cutting edge. The outer peripheral cutting edge 31 may have a straight line shape getting closer to the front end 3a as getting closer to the rotation axis O1.

The opening 23 may be located closer to the rotation axis O1 than the outer peripheral cutting edge 31 as in the non-limiting embodiment illustrated in FIG. 3. With this configuration, it is easy to maintain a thickness of the holder 3 on a rear side in the rotation direction Y1 with respect to the outer peripheral cutting edge 31. Accordingly, the holder 3 has high durability.

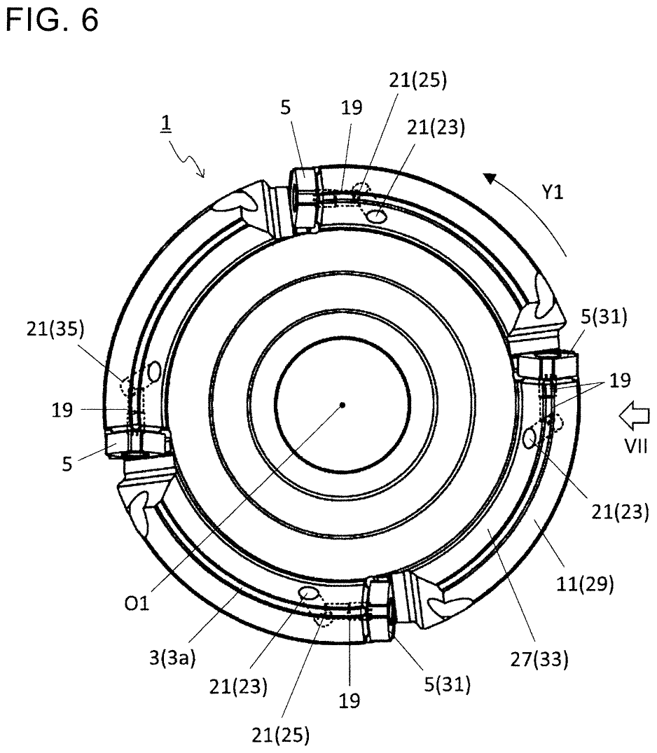

The connecting hole 21 may extend so as to get away from the outer peripheral surface 29 as getting closer to the opening 23 from the connecting part 25 as in a non-limiting embodiment illustrated in FIG. 6. With this configuration, it is easier to maintain the thickness of the holder 3 on the rear side in the rotation direction Y1 with respect to the outer peripheral cutting edge 31. Accordingly, the holder 3 has high durability.

The front end surface 27 may include an inclined surface 33 as in the non-limiting embodiment illustrated in FIG. 3. The inclined surface 33 may get closer to the rear end 3b as getting closer to the rotation axis O1. The inclined surface 33 may also be located closer to the rotation axis O1 than the outer peripheral cutting edge 31. The opening 23 may be located in the inclined surface 33. With these configurations, it is easy to maintain space between a machined surface (finished surface) and the opening 23. Therefore, chips are less likely to enter from the opening 23 into the connecting hole 21. Even if chips enter the connecting hole 21, the chips are less likely to be caught between the rotary tool 1 and the workpiece.

The opening 23 may have a circular shape. An inner diameter of the opening 23 may be equal to an inner diameter of an opening of the screw hole 19 located in the seating surface 17 (refer to FIG. 9). With this configuration, chips are less likely to enter from the opening 23 into the connecting hole 21. The phrase “the inner diameter of the opening 23 is equal to the inner diameter of the opening of the screw hole 19” as used herein is not limited to the configuration where two values are strictly equal. For example, there may be a difference of approximately 10% between the two values.

The connecting hole 21 may further include a concave part 35 which is located more away from the opening 23 than the connecting part 25, and includes a hole bottom. If the connecting part 25 includes the concave part 35, chips are less likely to enter the screw hole 19. This is because if the chips enter the connecting hole 21 from the opening 23, the chips tend to accumulate in the concave part 35.

A depth of the concave part 35 may be smaller than a length from the opening 23 to the connecting part 25 in a direction along a central axis of the connecting hole 21. With this configuration, it is easy to avoid excessive accumulation of the chips in the concave part 35, and it is easy to maintain rigidity of the holder 3.

For example, steel and cast iron are usable as a material of the holder 3. If the material of the holder 3 is steel, the holder 3 has high toughness.

For example, cemented carbide and cermet are usable as a material of the insert 5. Examples of composition of the cemented carbide may include WC—Co, WC—TiC—Co and WC—TiC—TaC—Co, in which WC, TiC and TaC may be hard particles, and Co may be a binding phase.

The cermet may be a sintered composite material obtainable by compositing metal into a ceramic component. Examples of the cermet may include titanium compounds composed mainly of titanium carbide (TiC) or titanium nitride (TiN). Needless to say, the material of the insert 5 is not limited to the above composition.

A surface of the insert 5 may be coated with a coating film by using chemical vapor deposition (CVD) method or physical vapor deposition (PVD) method. Examples of composition of the coating film may include titanium carbide (TiC), titanium nitride (TiN), titanium carbonitride (TiCN) and alumina (Al₂O₃).

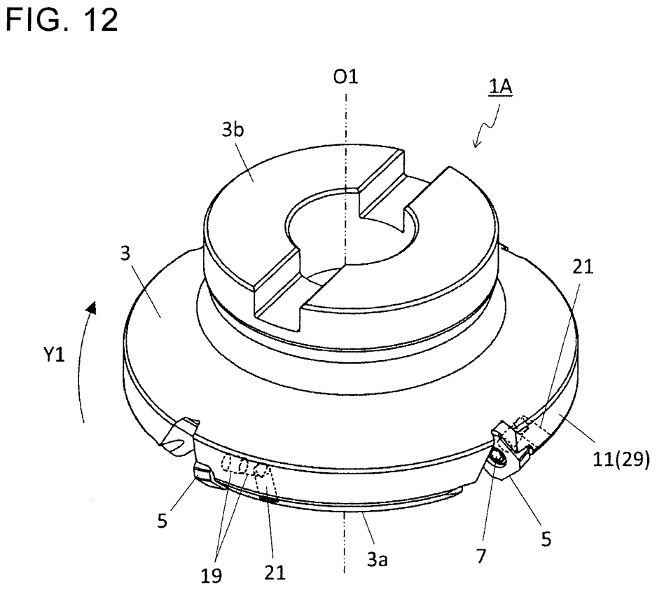

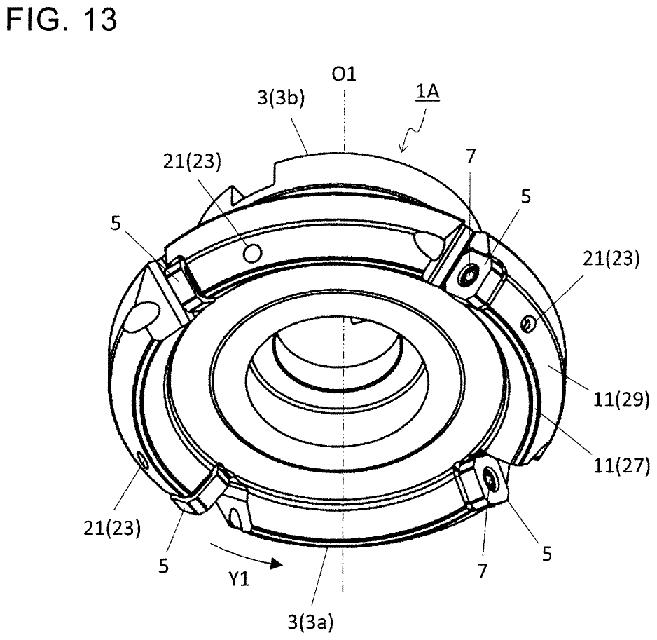

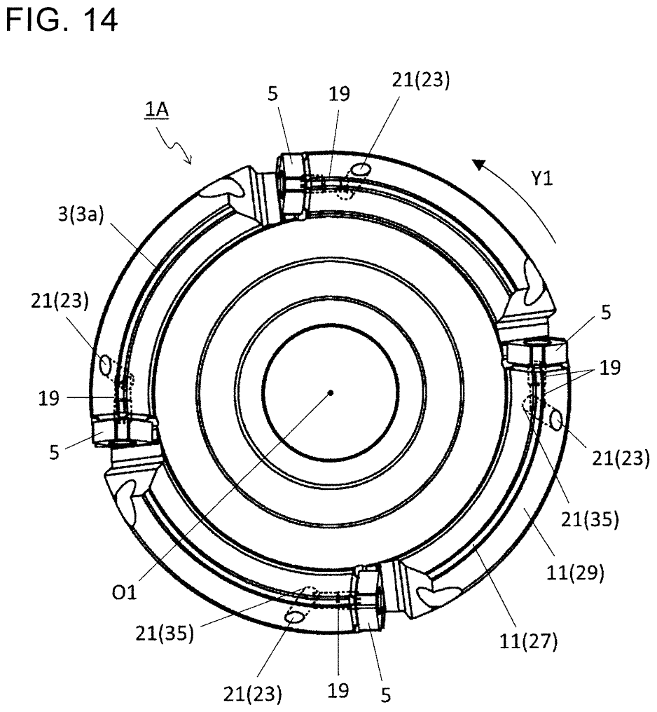

A rotary tool 1A in another non-limiting embodiment of the present disclosure is described below with reference to FIGS. 12 to 14. Differences between the rotary tool 1A and the rotary tool 1 are mainly described below, and a detailed description of a configuration that is the same as that of the rotary tool 1 may be omitted. Therefore, the description of the rotary tool 1 may be referred to in order to understand the configuration of the rotary tool 1A. This is also true for a rotary tool 1B described later.

An opening 23 may be located in an outer peripheral surface 29 in the rotary tool 1A as in the non-limiting embodiment illustrated in FIGS. 12 to 14. Chip jamming between the rotary tool 1A and a workpiece might occur in the vicinity of the opening 23. If the opening 23 is located in the outer peripheral surface 29, it is easy to avoid the chip jamming on a finished surface. Therefore, it is easy to improve machining accuracy.

A rotary tool 1B of still another non-limiting embodiment of the present disclosure is described below with reference to FIGS. 15 to 17.

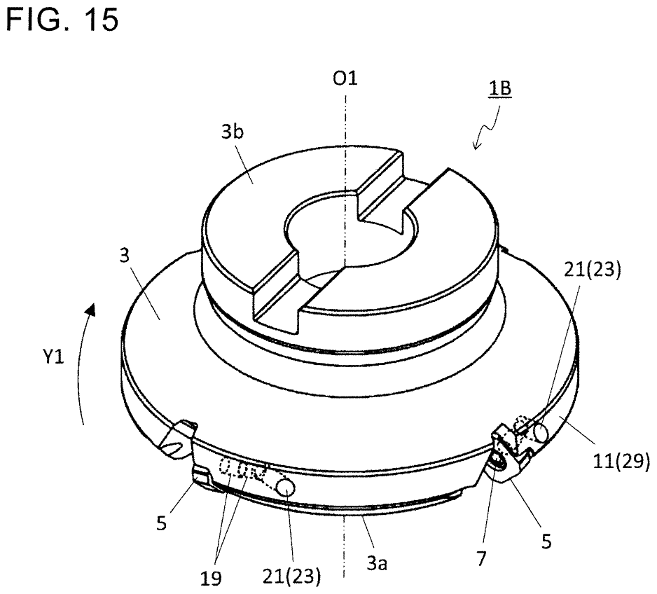

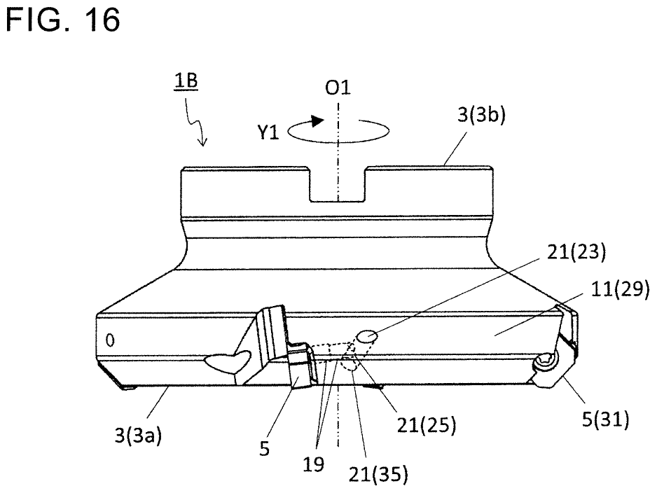

Similarly to the rotary tool 1A, an opening 23 may be located in an outer peripheral surface 29 in the rotary tool 1B (refer to FIG. 15). A connecting hole 21 may extend toward a rear end 3b as getting closer to the opening 23 from the connecting part 25 as in the non-limiting embodiment illustrated in FIG. 16. With these configurations, it is easy to avoid chip jamming between the rotary tool 1B and a workpiece in the vicinity of the opening 23. Therefore, it is easy to improve machining accuracy.

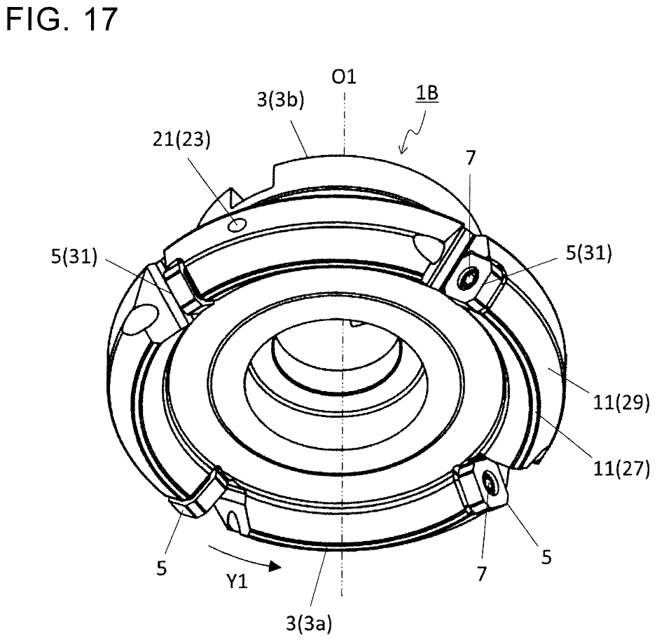

The opening 23 may be located closer to a rear end 3b than an outer peripheral cutting edge 31 as in the non-limiting embodiment illustrated in FIG. 17. With this configuration, it is easy to maintain a thickness of the holder 3 on a rear side in a rotation direction Y1 with respect to the outer peripheral cutting edge 31. This leads to high durability of the holder 3.

### Method for Manufacturing Machined Product

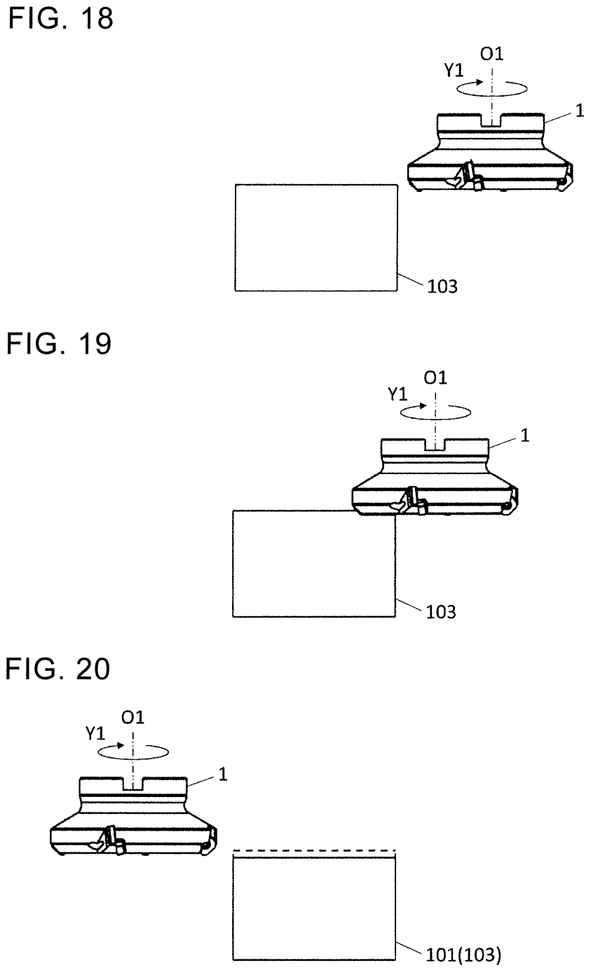

A method for manufacturing a machined product 101 in a non-limiting embodiment is described below with reference to FIGS. 18 to 20.

The machined product 101 may be manufactured by carrying out a machining process of a workpiece 103. The method for manufacturing the machined product 101 may include the following steps:
(1) Rotating the rotary tool 1 represented by the above non-limiting embodiment;
(2) Bringing the rotary tool 1 into contact with the workpiece 103; and
(3) Moving the rotary tool 1 away from the workpiece 103.

Specifically, firstly, the rotary tool 1 may be brought relatively near the workpiece 103 while rotating the rotary tool 1 in Y1 direction. Subsequently, the workpiece 103 may be cut out by bringing the insert 5 (cutting edge 13) in the rotary tool 1 into contact with the workpiece 103 as in the non-limiting embodiment illustrated in FIG. 19. Thereafter, the rotary tool 1 may be moved relatively away from the workpiece 103 as in the non-limiting embodiment illustrated in FIG. 20.

The machined product 101 whose finished surface has high accuracy is obtainable by going through the foregoing steps. Specifically, if the rotary tool 1 is used in the method for manufacturing the machined product 101, it becomes possible to exert excellent machinability because dust is less likely to accumulate on the bottom of the screw hole 19. Consequently, it becomes possible to obtain the machined product 101 whose machined surface has high accuracy.

Although the workpiece 103 is fixed and the rotary tool 1 is moved in the individual steps in the non-limiting embodiment illustrated in FIGS. 18 to 20, there is, of course, no intention to limit to this embodiment.

For example, the workpiece 103 may be brought near the rotary tool 1 in the step (1). Similarly, the workpiece 103 may be moved away from the rotary tool 1 in the step (3). If it is desired to continue the machining process, the step of bringing the insert 5 (cutting edge 13) in the rotary tool 1 into contact with different portions of the workpiece 103 may be repeated while keeping the rotary tool 1 rotated.

Examples of material of the workpiece 103 may include carbon steel, alloy steel, stainless steel, cast iron, and nonferrous metals.

Although the rotary tool 1 is used in the non-limiting embodiment illustrated in FIGS. 18 to 20, there is no intention to limit to this embodiment. For example, the rotary tool 1A or the rotary tool 1B may be used instead of the rotary tool 1.

### DESCRIPTION OF THE REFERENCE NUMERAL

1 rotary tool
3 holder
3a front end
3b rear end
5 cutting insert (insert)
7 screw
9 pocket
11 outer surface
13 cutting edge
15 through hole
17 seating surface
19 screw hole
21 connecting hole
23 opening
25 connecting part
27 front end surface
29 outer peripheral surface
31 outer peripheral cutting edge
33 inclined surface
35 concave part
101 machined product
103 workpiece
O1 rotation axis
Y1 rotation direction

1. A rotary tool, comprising:
a holder extending from a front end toward a rear end along a rotation axis, and comprising a pocket located on a side of the front end;
a cutting insert located in the pocket; and
a screw to fix the cutting insert to the holder, wherein
the pocket comprises
a seating surface facing toward a front side in a rotation direction of the rotation axis, and
a screw hole extending from the seating surface toward a rear side in the rotation direction, and being configured to fix the screw,
the holder further comprises a connecting hole connecting to the screw hole,
the connecting hole comprises
an opening that opens into an outer surface of the holder, and
a connecting part connecting to the screw hole, and
the opening is located on a more rear side in the rotation direction than the connecting part.

2. The rotary tool according to claim 1, wherein the connecting hole extends toward a rear side in the rotation direction as getting closer to the opening from the connecting part.

3. The rotary tool according to claim 1, wherein
the outer surface of the holder comprises
a front end surface located on a side of the front end, and
an outer peripheral surface extending from the front end surface toward the rear end, and
the opening is located in the outer peripheral surface.

4. The rotary tool according to claim 3, wherein the connecting hole extends toward the rear end as getting closer to the opening from the connecting part.

5. The rotary tool according to claim 3, wherein
the cutting insert comprises an outer peripheral cutting edge located on an outer peripheral side, and
the opening is located closer to the rear end than the outer peripheral cutting edge.

6. The rotary tool according to claim 1, wherein
the outer surface of the holder comprises
a front end surface located on a side of the front end, and
an outer peripheral surface extending from the front end surface toward the rear end, and
the opening is located in the front end surface.

7. The rotary tool according to claim 6, wherein the connecting hole extends toward the front end as getting closer to the opening from the connecting part.

8. The rotary tool according to claim 6, wherein
the cutting insert comprises an outer peripheral cutting edge located on an outer peripheral side, and
the opening is located closer to the rotation axis than the outer peripheral cutting edge.

9. The rotary tool according to claim 8, wherein the connecting hole extends so as to get away from the outer peripheral surface as getting closer to the opening from the connecting part.

10. The rotary tool according to claim 6, wherein
the front end surface comprises an inclined surface getting closer to the rear end as getting closer to the rotation axis, and
the opening is located in the inclined surface.

11. A method for manufacturing a machined product, comprising:
rotating the rotary tool according to claim 1;
bringing the rotary tool into contact with a workpiece; and
moving the rotary tool away from the workpiece.
